(19) United States
(12) Patent Application Publication
(10) Pub. No.: US 2008/0009320 A1
(43) Pub. Date: Jan. 10, 2008

(54) Apparatus, method and software product involving retransmission strategy for a multicast service on a high speed transport channel

(76) Inventors: Kari Rikkinen, Ii (FI); Jorma Kaikkonen, Oulu (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/825,124

(22) Filed: Jul. 2, 2007

Related U.S. Application Data
(60) Provisional application No. 60/817,786, filed on Jun. 30, 2006.

(51) Int. Cl. H04B 1/38

(52) U.S. Cl. 455/560

(57) ABSTRACT

An apparatus, method, and software product are used for transmitting a broadcast or multicast. Then, indications are received from various user equipments that reception was not adequate. A record of those indications is kept, and based upon that record a determination is made whether the indications collectively reach a threshold. If the threshold is reached then packets are retransmitted or increasingly retransmitted.

### CROSS REFERENCE TO RELATED APPLICATION

The present application claims priority to U.S. Provisional Application No. 60/817,786 filed Jun. 30, 2006.

### BACKGROUND OF THE INVENTION

1. Technical Field

The present invention pertains to the field of telecommunications. More particularly, the present invention pertains to a multicast service on a transport channel.

2. Discussion of Related Art

High-Speed Downlink Packet Access (HSDPA) is a mobile telephony protocol and is sometimes referred to as a 3.5 G (or “3½ G”) technology. In this respect it extends Wideband Code Division Multiple Access (WCDMA). HSDPA provides a smooth evolutionary path for Universal Mobile Telecommunications System (UMTS) networks allowing for higher data capacity (up to 14.4 Mbit/s in the downlink). It is an evolution of the WCDMA standard, designed to increase the available data rate by a factor of 5 or more. HSDPA defines a new WCDMA channel, the high-speed downlink shared channel (HS-DSCH) that operates in a different way from existing WCDMA channels, but is only used for downlink communication to the mobile.

HSDPA signal usage for point-to-multipoint (p-t-m) Multimedia Broadcast Multicast Service (MBMS) connections is a relatively new topic that has not been included in 3GPP specifications by Release 6. The Release 6 of the Third Generation Partnership Project (3GPP) did describe various features of a Multimedia Broadcast Multicast Service (MBMS). The technical report 3GPP TR 25.992, “Multimedia Broadcast/Multicast Service (MBMS); UTRAN/GERAN requirements, Version 6.0.0 (2003-09)” is incorporated by reference herein, and describes an MBMS (Broadcast/Multicast) Session as a continuous and time-bounded reception of a broadcast/multicast service by the user equipment (UE). A single broadcast/multicast service can only have one broadcast/multicast session at any time, but may consist of multiple successive broadcast/multicast sessions. MBMS includes both a broadcast mode, which is the part of MBMS that supports broadcast services, as well as a multicast mode, which is the part of MBMS that supports multicast services. Quality of service attributes are the same for MBMS Multicast and Broadcast modes.

Technical Report 25.992 additionally explains that MBMS data transfer occurs in the downlink only. During this MBMS data transmission, paging messages can be received. However, simultaneous reception of MBMS and non-MBMS services depend upon UE capabilities, and likewise simultaneous reception of more than one MBMS services also depends upon UE capabilities. A notification procedure is used to indicate the start of MBMS data transmission. Mechanisms are required to enable the Network to move MBMS subscribers between cells, and to enable the non-transmission of MBMS multicast mode in a cell which does not contain any MBMS UEs joined to the multicast group. MBMS does not support individual retransmissions at the radio link layer, nor does it support retransmissions based on feedback from individual subscribers at the radio level. However, this does not preclude the periodic repetitions of the MBMS content based on operator or content provider scheduling or retransmissions based on feedback at the application level. MBMS Multicast mode transmissions should use dedicated resources (p-t-p) or common resources (p-t-m), and the selection of the connection type (p-t-p or p-t-m) is operator-dependent, typically based on the downlink radio resource environment such as radio resource efficiency; a “threshold” related to the number of users may be utilized, resulting in the need for a mechanism to identify the number of subscribers in a given area.

According to Release 6, the MBMS is specified at the physical layer level in the following way, depending upon the number of users. For point-to-multipoint (p-t-m) transmission, the MBMS uses a Forward Access Transport Channel (FACH) mapped onto a Secondary Common Control Physical Channel (S-CCPCH). For point-to-point (p-t-p) transmission, the MBMS uses a Dedicated Transport Channel (DCH) mapped to a Dedicated Physical Data Channel (DPDCH).

Hybrid Automatic Repeat Request (HARQ) retransmissions can be used to provide improved coverage and/or throughput for a HSDPA-based MBMS service. When there are multiple UEs with very different channel conditions belonging to the same multicast group, UE's being in a poor channel condition could cause a situation where always at least one negative acknowledgment (NACK) is received by the Node B (i.e. the base station) dictating the need for retransmissions in a HSDPA MBMS system. However, no reliable and efficient method for accomplishing such retransmissions has yet been developed, partly because HSDPA signal usage for p-t-m MBMS connections is a new topic and has not been included in 3GPP specifications by Release 6.

### DISCLOSURE OF THE INVENTION

When the Node B receives channel quality indicator (CQI) requests and/or ACK/NACKs from multiple HSDPA MBMS UEs, the Node B decides whether to retransmit previous MBMS data block, or increase the number of re-transmissions for forthcoming MBMS data blocks, based upon statistics of received ACKs/NACKs. For instance, if a particular threshold is reached based upon the statistics, then retransmission begins (or is increased). The CQI report is not absolutely necessary, because the NACK's should be sufficient. However, if CQI reports are available, they can be used to weight the impact of NACK of a given UE, e.g. regarding the variation in the received CQI reports. NACKs from UE's reporting higher CQI's would have a lesser effect or no effect upon threshold evaluation.

This solution enables improvements in spectrum efficiency in MBMS service delivery by allowing the Node B to adjust the criteria for retransmissions based on collective data from all MBMS UEs belonging to the same multicast group

### BRIEF DESCRIPTION OF THE DRAWINGS

FIG. 1 presents HSDPA MBMS transmission system.

FIG. 2 is a flow chart of an embodiment of the invention.

FIG. 3 is a block diagram of a network element apparatus according to an embodiment of the invention.

### BEST MODE FOR CARRYING OUT THE INVENTION

An embodiment of the present invention will now be detailed with the aid of the accompanying figures. It is to be understood that this embodiment is merely an illustration of one particular implementation of the invention, without in any way foreclosing other embodiments and implementations.

A Node B receives NACKs from all HSDPA MBMS UEs, requesting retransmission for the same multicast group. If at least a threshold percentage (X %) of the HSDPA MBMS UEs request retransmission, then the Node B retransmits a previous MBMS data block, but otherwise does not. The parameter X % can be based on longer term statistics of received NACKs within the multicast group. If the UE in poorest channel condition varies in time, then all UEs could meet an assumed transmission quality that is poor enough to trigger retransmissions, even putting aside whether or not there were retransmission requests. The information on the UE channel conditions, if available through CQI reports, can also be used to determine weight and/or impact of the received NACK signal upon threshold evaluation.

Furthermore, rather than the Node B making a decision for the latest packet to be re-transmitted, a scheduler at the network side may decide to instead initiate re-transmissions or increase re-transmissions for future packets, thus adapting a more pre-emptive strategy. Rather than trying to correct the erroneous packets of the past, this strategy provides additional re-transmissions for future transmissions, if it is observed that the quality of the connection has fallen below a certain desired level.

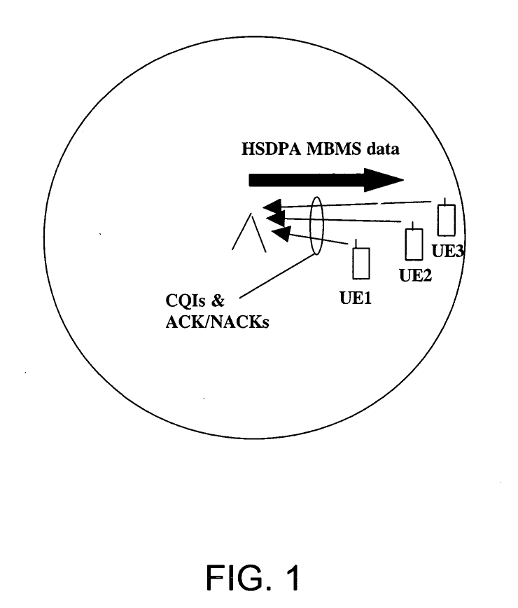

As seen in FIG. 1, user equipments UE1, UE2, and UE3 transmit CQIs and/or ACK/NACKs to a base station, in response to HSDPA MBMS data. This information from the UEs is used to calculate whether the MBMS data should be retransmitted (or whether retransmission should be increased, reduced, or maintained).

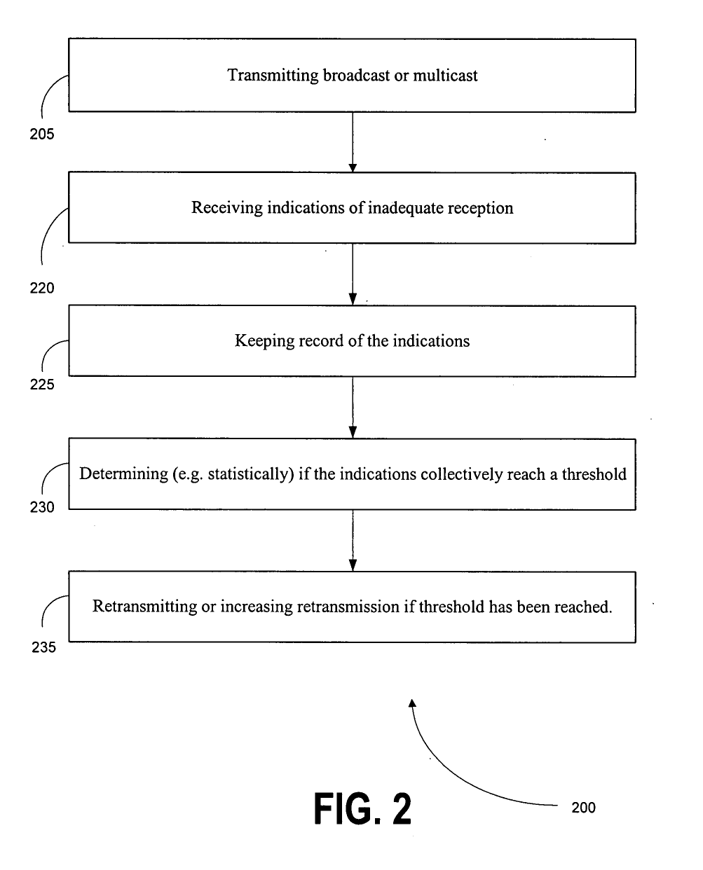

Turning now to FIG. 2, a flow chart shows a method 200 according to an embodiment of the invention. A broadcast or multicast is transmitted 205, and then indications are received 220 from a plurality of user equipments indicating inadequate reception. A record is kept 225 of the indications. Then a determination is made 230 whether the indications collectively reach a threshold. If so, retransmission (or increased retransmissions) of packets are sent 235 to UEs.

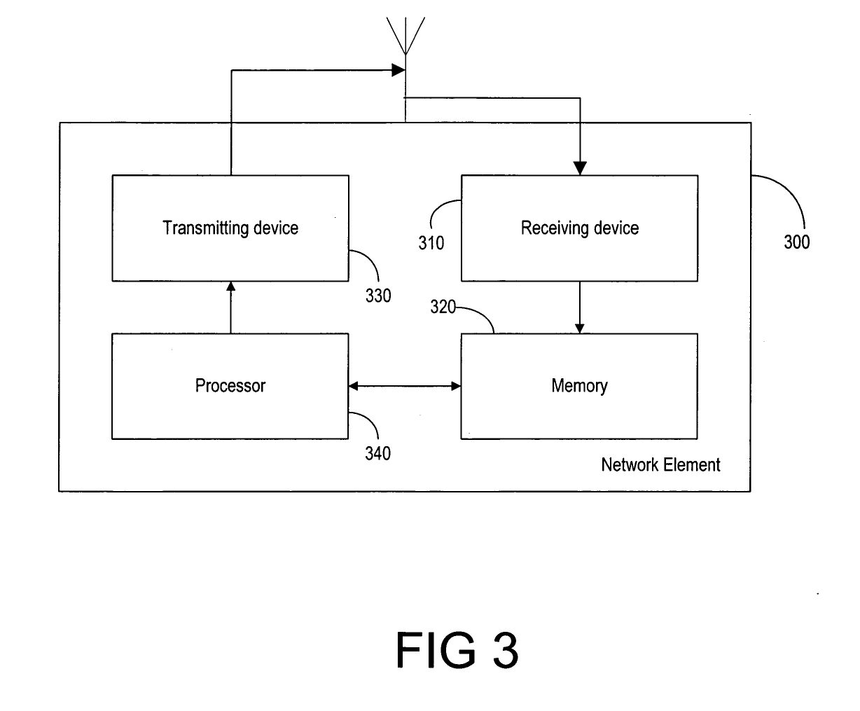

Referring now to FIG. 3, a block diagram of a network element apparatus 300 is shown. The transmitting device 330 is configured to transmit a broadcast or multicast, via an antenna. The receiving device 310 is configured to receive indications (via the antenna) from a plurality of user equipments indicating inadequate reception. The memory 320 is configured to keep a record of the indications. The processor 340 is configured to determine whether the indications collectively reach a threshold. The transmitting device 330 includes a retransmission module (not shown) which is configured to retransmit or increase retransmissions of packets, if the processor 340 determines that the threshold has been reached.

Of course, the present invention also includes a software product for performing the embodiment of the method described above, and the software can be implemented using a general purpose or specific-use computer system, with standard operating system software conforming to the method described herein. The software is designed to drive the operation of the particular hardware of the system, and will be compatible with other system components and I/O controllers. The computer system of this embodiment includes a CPU processor such as processor 340 shown in FIG. 3, comprising a single processing unit, multiple processing units capable of parallel operation, or the CPU can be distributed across one or more processing units in one or more locations, e.g., on a client and server, or within other components. The memory 320 may comprise any known type of data storage and/or transmission media, including magnetic media, optical media, random access memory (RAM), read-only memory (ROM), a data cache, a data object, or the like. Moreover, similarly to the CPU, the memory may reside at a single physical location, comprising one or more types of data storage, or be distributed across a plurality of physical systems in various forms.

It is to be understood that all of the present figures, and the accompanying narrative discussions of corresponding embodiments, do not purport to be completely rigorous treatments of the method, apparatus, system, and software product under consideration. A person skilled in the art will understand that the steps and signals of the present application represent general cause-and-effect relationships that do not exclude intermediate interactions of various types, and will further understand that the various steps and structures described in this application can be implemented by a variety of different sequences and configurations, using various combinations of hardware and software which need not be further detailed herein.

What is claimed is:

1. A method, comprising:
transmitting a broadcast or multicast;
receiving indications from a plurality of user equipments of inadequate reception;
keeping a record of the indications;
determining whether the indications collectively reach a threshold; and
retransmitting or increasing retransmissions of packets if the threshold is reached.

2. The method of claim 1, wherein the packets include past packets from a previous data block, or future packets from future transmissions, or both.

3. The method of claim 1, wherein the indications include negative acknowledgments.

4. The method of claim 1, wherein the threshold is a certain percentage of user equipments providing the indications.

5. An apparatus, comprising:
means for transmitting a broadcast or multicast;
means for receiving indications from a plurality of user equipments of inadequate reception;
means for keeping a record of the indications;
means for determining whether the indications collectively reach a threshold; and
means for retransmitting or increasing retransmissions of packets if the threshold is reached.

6. The apparatus of claim 5, wherein the packets include past packets from a previous data block, or future packets from future transmissions, or both.

7. The apparatus of claim 5, wherein the indications include negative acknowledgments.

8. The apparatus of claim 5, wherein the threshold is a certain percentage of user equipments providing the indications.

9. An apparatus comprising:
a transmitting device configured to transmit a broadcast or multicast;
a receiving device configured to receive indications from a plurality of user equipments of inadequate reception;
a memory configured to keep a record of the indications;
a processor configured to determine whether the indications collectively reach a threshold; and
a retransmission module configured to retransmit or increase retransmissions of packets if the threshold is reached.

10. The apparatus of claim 9, wherein the packets include past packets from a previous data block, or future packets from future transmissions, or both.

11. The apparatus of claim 9, wherein the indications include negative acknowledgments.

12. The apparatus of claim 9, wherein the threshold is a certain percentage of user equipments providing the indications.

13. A computer program product including a computer-readable medium having computer-executable components comprising:
a component for transmitting a broadcast or multicast;
a component for receiving indications from a plurality of user equipments of inadequate reception;
a component for keeping a record of the indications;
a component for determining whether the indications collectively reach a threshold; and
a component for retransmitting or increasing retransmissions of packets if the threshold is reached.

14. The computer program product of claim 13, wherein the packets include past packets from a previous data block, or future packets from future transmissions, or both.

15. The computer program product of claim 13, wherein the indications include negative acknowledgments.

16. The computer program product of claim 13, wherein the threshold is a certain percentage of user equipments providing the indications.

17. A system, comprising:
a base station configured to transmit a broadcast or multicast;
a plurality of user equipments configured to transmit to the base station indications of inadequate reception;
wherein the base station is further configured to determine whether the indications collectively reach a threshold, and to retransmit or increase retransmissions of packets if the threshold is reached.

18. The system of claim 17, wherein said packets include past packets from a previous data block, or future packets from future transmissions, or both.

19. The system of claim 17, wherein the indications include negative acknowledgments.

20. The system of claim 17, wherein the threshold is a certain percentage of user equipments providing the indications.
